(19) United States
(12) Patent Application Publication
(10) Pub. No.: US 2013/0052370 A1
(43) Pub. Date: Feb. 28, 2013

(54) METHOD FOR DEPOSITING A CATALYTIC LAYER FOR A FUEL CELL

(71) Applicants: Marjorie Cavarroc, Bondoufle (FR); Matthieu Vogt, Varenne (FR); Aboubakr Ennajdaoui, Clermont Ferrand (FR)

(72) Inventors: Marjorie Cavarroc, Bondoufle (FR); Matthieu Vogt, Varenne (FR); Aboubakr Ennajdaoui, Clermont Ferrand (FR)

(73) Assignee: DREUX AGGLOMERATION, Dreux (FR)

(21) Appl. No.: 13/695,280

(22) PCT Filed: Apr. 28, 2011
(86) PCT No.: PCT/EP2011/056712

§ 371 Date: Oct. 29, 2012

(30) Foreign Application Priority Data
Apr. 30, 2010 (FR) 1053352

(51) Int. Cl. H01M 4/88; B82Y 40/00

(52) U.S. Cl. 427/575; 427/569; 427/576; 977/891

(57) ABSTRACT

The present invention relates to a method for manufacturing a fuel cell electrode (E) by depositing a catalytic layer (2) on a diffusion layer (3), characterized in that said catalyst is deposited on the diffusion layer (3) by ionized physical vapor deposition (IPVD) in a vacuum chamber.

The invention also relates to a method for manufacturing a fuel cell half-core comprising an ionic membrane (1), a catalytic layer (2) and a diffusion layer (3) by depositing the catalytic layer (2) on a support (1; 3), characterized in that said catalyst is deposited on the support (1; 3) by ionized physical vapor deposition (IPVD) in a vacuum chamber.

### FIELD OF THE INVENTION

The present invention relates to a method for depositing a catalytic layer on a support with view to producing fuel cell electrodes and/or cores in thin layers.

### BACKGROUND OF THE INVENTION

Fuel cell cores typically comprise three elements: a solid or liquid electrolyte, inserted between an anode and a cathode.

In the case of so-called “low temperature” cells, i.e. PEMFCs (acronym of Proton Exchange Membrane Fuel Cell, operating with hydrogen) and DMFCs (acronym of Direct Methanol Fuel Cell operating with methanol), the electrolyte is solid and generally of a polymeric nature with an ionic character. As such, as an example, mention may be made of the membrane Nafion®.

This type of electrolyte (membrane) has an operating temperature range generally comprised between 60 and about 90° C. The membrane contains sulfonic or phosphonic acid functions responsible for proton conduction.

During operation, on the side of the anode, oxidation of the hydrogen produces protons and electrons.

The protons cross the membrane as far as the cathode, while the electrons at the origin of the current produced, pass into the electric circuit in order to feed an external load.

The electrodes generally consist of carbon catalyzed for example with platinum.

The most common method for producing these electrodes consists of coating a carbonaceous support or a gas diffusion layer, also designated by the acronym “GDL” (Gas Diffusion Layer) of catalyzed carbon ink, essentially elaborated via a chemical route.

However, it was seen that in an operating conventional fuel cell, only a very small amount of the catalyst is actually used and the efficiency of the latter is not optimum.

It is therefore desirable, for both economical and environmental reasons, to increase the rate of use of the catalyst used, and/or to improve its catalytic efficiency, as well as reduce the amount of catalyst used while maintaining the electrochemical performances of the cell.

Document WO 2007/063244 tries to solve this problem and proposes the making of carbon electrodes by depositing porous carbon and a catalyst on a support by plasma sputtering in a vacuum chamber.

According to this method, the thickness of each porous carbon layer is selected so that the catalyst deposited on said layer is diffused into the thickness, so as to form a carbon layer catalyzed both in the bulk and at the surface.

However, this method does not provide the improvement reckoned with, in terms of catalytic efficiency.

Moreover, it requires the availability of two targets (carbon and catalyst targets) in the vacuum chamber.

Document FR 2 843 896 and the articles of Caillard et al, “Deposition and diffusion of platinum nanoparticles in porous carbon assisted by plasma sputtering”. Surface and Coatings Technology, ELSEVIER, Vol. 200, No. 1-4, Oct. 1, 2005, pages 391-394. Hirano et al., “High performance proton exchange membrane fuel cells with sputter-deposited Pt layer electrodes”, Electrochimica Acta, Elsevier Science Publishers, Vol. 41, No. 10, Jan. 1, 1997, pages 1587-1593. Witham et al., “Performance of direct methanol fuel cells with sputter-deposited anode catalyst layers”, Electrochemical and Solid-State Letters, IEEE Service Center, Vol. 3, No. 11, Nov. 1, 2000, pages 497-500, Cha et al., “Performance of proton exchange membrane fuel cell electrodes prepared by direct deposition of ultrathin platinum on the membrane surface”, Journal of the Electrochemical Society, Vol. 146, No. 11, Jan. 1, 1999, pages 4055-4060 and Slavcheva et al., “Sputtered electrocatalysts for PEM electrochemical energy converters”, Electrochemica Acta, Elsevier Science Publishers, Vol. 53, No. 2, Oct. 11, 2007, pages 362-368, also deal with the application of plasma sputtering for making fuel cells.

Moreover document WO 03/044240 describes a method for manufacturing fuel cell cores by successive plasma sputtering of carbon, of catalysts and of a conducting material on a support.

This method uses a vacuum chamber divided into several sections, and including several anodes and charge screens. This device is therefore relatively complex.

Further, it is based on a cathodic arc deposition technique.

Now, the arc plasma generally has a high temperature, which implies that the deposition should be carried out on a substrate withstanding this temperature, which notably excludes deposition on present polymeric membranes.

The object of the invention is therefore to overcome the drawbacks of the methods of the prior art and to propose a method for manufacturing electrodes which is simpler, more complete, which consumes less catalyst and which provides better catalytic efficiency.

### SHORT DESCRIPTION OF THE INVENTION

According to the invention, a method for manufacturing a fuel cell electrode by deposition of a catalytic layer on a diffusion layer is proposed, in which said catalyst is deposited on the difusion layer by ionized physical vapor deposition (IPVD) in a vacuum chamber.

According to a second aspect, the invention also relates to a method for manufacturing a fuel cell half-core comprising an ionic membrane and an electrode comprising a catalytic layer and a diffusion layer, by depositing the catalytic layer on a support, in which said catalyst is deposited on the support by ionized physical vapor deposition (IPVD) in a vacuum chamber.

Generally, the invention therefore deals with a method in which a catalytic layer is deposited on a support by ionized physical vapor deposition in a vacuum chamber in order to form a fuel cell electrode (the support then being the diffusion layer) or a fuel cell half-core (the support may either be the diffusion layer or the ionic membrane).

Unlike the plasma sputtering methods mentioned in the preamble, in which the catalyst is deposited in the form of neutral particles, the catalyst is deposited in the present invention in an at least partly ionized form.

According to a particular embodiment of said fuel cell half-core, the support is an ionic membrane and a catalytic layer is deposited on each side of said support.

Preferably, the ionic membrane of the fuel cell half-core is an ionic polymeric membrane.

In the method according to the invention, the ionization of the catalyst is obtained by a radio frequency or microwave antenna placed in the chamber between the catalyst target and the support on which is deposited the catalyst.

Preferably, the plasma is an argon plasma at a pressure comprised between 10⁻³ and 1 mbar.

Alternatively, at least one gas selected from hydrogen, nitrogen, oxygen and rare gases in a lesser amount than that of argon may be added to the argon.

The deposited catalyst is advantageously selected from platinum, palladium, platinoid alloys, non-platinoid metals, alloys of said metals, nitrides or oxides of said metals.

More advantageously, the surface load or mass of catalysts is less than 100 μg/cm² of electrode.

Moreover, the thickness of the catalytic layer is typically less than 2 micrometers, preferably comprised between 10 and 100 nm.

Another object relates to a fuel cell electrode or a fuel cell half-core obtained according to the method which has just been described. The invention also relates to a fuel cell comprising at least such an electrode or such a fuel cell half-core.

### SHORT DESCRIPTION OF THE DRAWINGS

Other features and advantages of the invention will become apparent from the detailed description which follows, with reference to the appended drawings wherein:

FIG. 1 schematically illustrates the structure of a fuel cell half-core comprising an ionic membrane and an electrode consisting of a catalytic layer and a diffusion layer;

FIG. 2 is a schematic perspective view of an ionized plasma sputtering device according to the invention;

FIG. 3 is a side view of the device illustrated in FIG. 2;

FIG. 4 illustrates results of comparative tests of two methods for manufacturing electrodes.

### DETAILED DESCRIPTION OF THE INVENTION

The deposition method described hereafter is applied to the manufacturing of fuel cell electrodes or half-cores such as PEMFCs (acronym of Proton Exchange Membrane Fuel Cell) or DMFCs (acronym of Direct Methanol Fuel Cell).

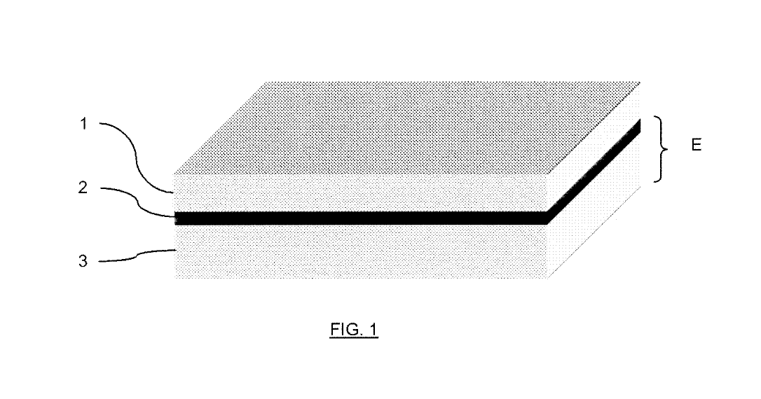

With reference to FIG. 1, the fuel cell half-core comprises the superposition of an ionic membrane 1 and of an electrode E comprising a catalytic layer 2, the catalyst of which is deposited in ionized form and a diffusion layer 3.

The term of “membrane” comprises in the present text all the range of membranes with an ionic character.

Proton conduction is ensured either by sulfonic acid —SO₃H functions or by phosphonic acid —PO₃H functions.

As a non-limiting example, mention may be made of perfluorinated membranes (Nafione®, Flemion®, . . . etc.), modified perfluorinated membranes by adding mineral or other compounds, polymer alternative membranes, acid-based complexes, ionic liquids and plasma membranes.

The catalyst is any suitable catalyst for accelerating at least one of the chemical reactions taking place in the fuel cell.

Typically, the catalyst is selected from platinum, palladium, platinoid alloys, non-platinoid metals, or alloys of these different metals.

Moreover, the layer 2 may comprise, in addition to the catalyst, other elements, notably carbon.

The catalytic layer is obtained by an ionized plasma sputtering technique in a vacuum chamber, in which the catalyst in an ionized form is deposited on a support.

Preferably, the support is the membrane 1 of the fuel cell.

However, alternatively, the support may also be the diffusion layer 3.

As a general rule, the diffusion layer better withstands the deposition of the catalyst since it may be exposed to higher temperatures than the polymeric membrane.

However, by depositing the catalyst directly on the membrane, the catalytic efficiency is in principle improved while giving the possibility of having more triple point contacts (i.e. contact between the gases, the ions and the electrons) for the catalysis.

The applied method is an ionized plasma sputtering method (known under the acronym of IPVD or “Ionized Physical Vapor Deposition”).

The general principles of this technique are described in the articles of J. T. Gudmundsson, “Ionized physical vapor deposition (IPVD): Magnetron sputtering discharges”, Journal of Physics: Conference Series 100 (2008) 082002 and of de Poucques et al., “Study of the transport of titanium neutrals and ions in the post-discharge of a high power pulsed magnetron sputtering device”, Plasma Sources Sci. Technol. 15 (2006) 661-669.

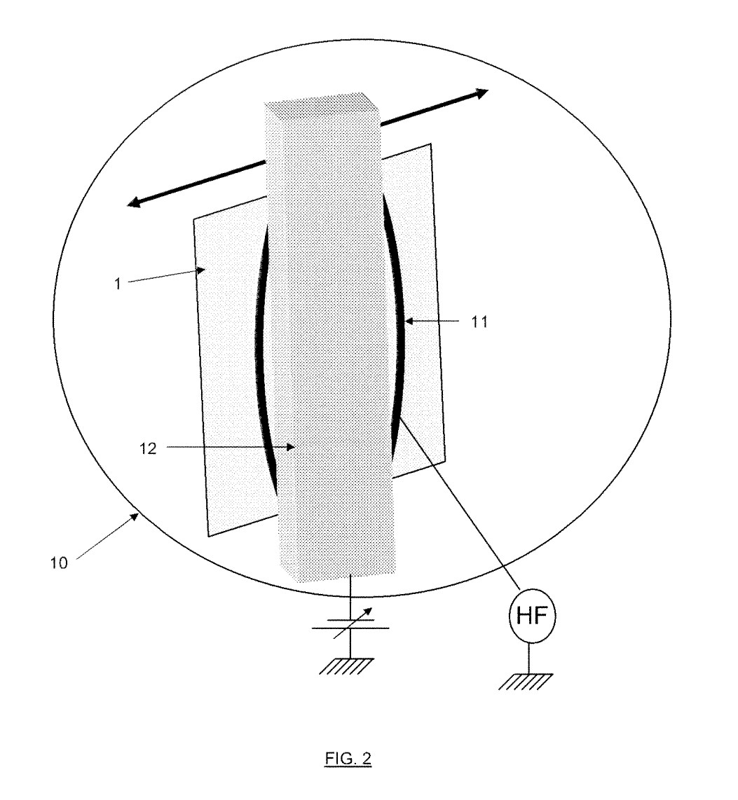

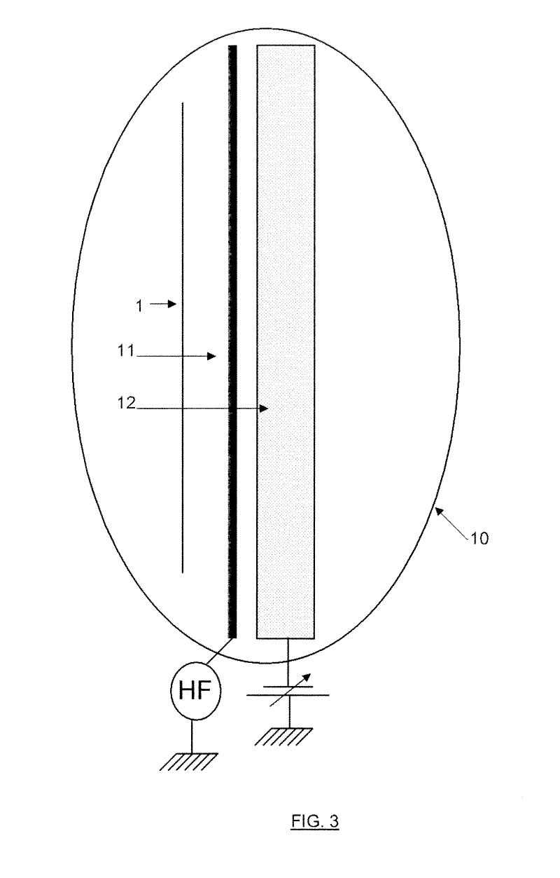

For this purpose, with reference to FIGS. 2 and 3, the support (here the membrane 1) is placed in a vacuum chamber 10 in which is also found a cathode 12 supporting the target containing the catalyst.

The plasma is preferably generated from argon, optionally added with a lesser amount of hydrogen, nitrogen, oxygen and/or rare gases.

The argon pressure is comprised between 10⁻³ and 1 mbar.

The plasma is generated by coupling a high voltage on a sputtering device (magnetron or other device).

The argon ions subject to the electromagnetic field bombard the target(s) and release atoms which are projected towards the support.

The deposited layers may be obtained from sputtering of several types of targets: pure targets (target of catalysts, carbon target, . . . ) and/or alloys.

For the latter, the target may be a single-phase or composite target.

In both cases, the proportion and the composition of the alloys is variable.

All the possible combinations of pure targets and/or alloys may be utilized for the deposition, and this either alternately (successions of deposits from two targets at least), or simultaneously (simultaneous deposition from two targets at least).

The device further comprises a high frequency antenna 11 (radio frequency or microwave antenna) placed between the cathode 12 supporting the target and the support 1, which allows ionization (either partial or total ionization) of the catalyst detached from the target before its deposition on the support.

In the case of the use of radio frequency technology, this is referred to as an “ICP” (acronym of Inductively Coupled Plasma, the frequency used being 13.56 MHz or one of its multiples).

In the case of the use of microwave technology, this is referred to as an “ECR plasma” (acronym of Electron Cyclotron Resonance); the frequency used being 2.4 GHz or one of its multiples.

If the deposition of the catalytic layer is carried out on the membrane, the fuel cell half-core is formed by putting the diffusion layer, for example as a carbonaceous fabric, in contact with the catalytic layer.

The core of the fuel cell is formed by the association of two electrodes on either side of a membrane.

Deposition of both catalytic layers 2 may take place simultaneously on both sides of the membrane 1 at the same time.

This method has the advantage of being able to be applied at relatively low temperatures, i.e. not exceeding 90° C., which allows the ionized catalyst to be deposited on polymeric membranes, the maximum stability temperature of which does not exceed 90° C.

With this deposition method, it is possible to very finely control the thickness of the catalytic layers and therefore of the electrodes and of the cell cores.

Consequently, elaboration of deposits with small thicknesses for making catalytic layers with a thickness of less than 1 or 2 μm, may absolutely be contemplated.

Further, the method gives the possibility of depositing the catalyst at very low loads (less than 100 μg.cm⁻²) with thicknesses comprised between about ten and about a hundred nanometers.

As an example, co-sputtering of a carbon-platinum single-phase target gave the possibility of generating in the cell (of the PEMFC type) a mass specific power of 20 kW per gram of platinum.

This result is exceptional considering the very small platinum load: 10 μg.cm⁻².

Ionization of the catalyst by IPVD is of considerable interest since it allows a gain of the order of 20% in the performances for the electrodes tested in cells, as compared with those carried out under the same conditions without providing ionization.

In an assembly with the Nafion® membrane, the power delivered by the cell (of the PEMFC type) attains more than 0.85 W.cm⁻² although the load is only 38 μg.cm⁻².

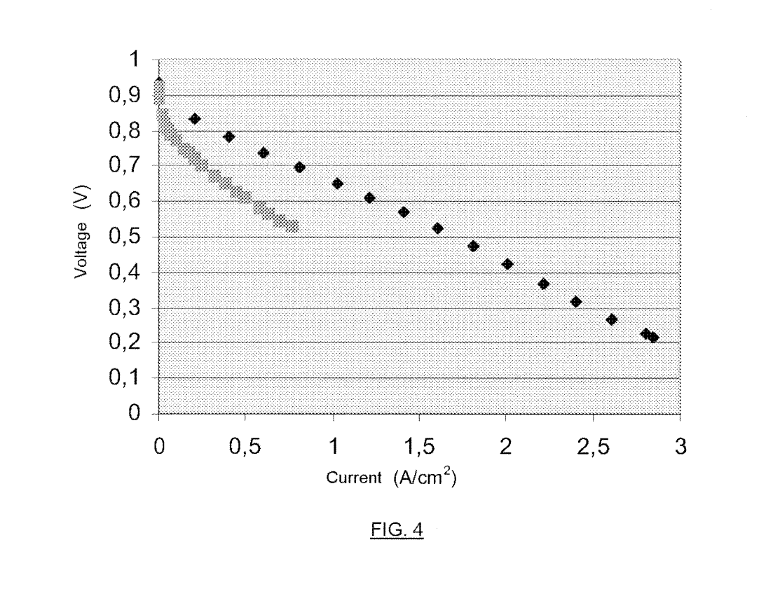

FIG. 4 illustrates the comparative results respectively obtained with:
the method described in document WO 2007/063244 (series of squares), with 0.2 mg of Pt per cm² of electrode. The attained maximum power is 0.4 W/cm².
the method of the invention (series of lozenges), with 0.038 mg of Pt per cm² of electrode. The attained maximum power is 0.855 W/cm².

This result therefore demonstrates the catalytic efficiency of the platinum deposited in an ionized form.

Of course, as discussed above, the method is not limited to the deposition of platinum as a catalyst but may comprise the deposition of other catalysts, optionally in combination with other materials such as carbon.

1. A method for manufacturing a fuel cell electrode by depositing a catalytic layer on a diffusion layer, wherein said catalyst is deposited on the diffusion layer by ionized physical vapor deposition (IPVD) in a vacuum chamber.

2. A method for manufacturing a fuel cell half-core comprising an ionic membrane and an electrode comprising a catalytic layer and a diffusion layer by depositing the catalytic layer on a support, wherein said catalyst is deposited on the support by ionized physical vapor deposition (IPVD) in a vacuum chamber.

3. The method of claim 2, wherein the support is an ionic membrane and in that a catalytic layer is deposited on each side of the support.

4. The method of claim 2, wherein the ionic membrane is a polymeric membrane.

5. The method of claim 1 or claim 2, wherein the ionization of the catalyst is obtained by a radio frequency or microwave antenna placed in the chamber between the catalyst target and the support on which the catalyst is deposited.

6. The method of claim 1 or claim 2, wherein the plasma is an argon plasma with a pressure comprised between 10⁻³ and 1 mbar.

7. The method of claim 6, wherein at least one gas selected from hydrogen, nitrogen, oxygen and rare gases is added to the argon, in a lesser amount than that of the argon.

8. The method of claim 1 or claim 2, wherein the catalyst is selected from platinum, palladium, platinoid alloys, non-platinoid metals, alloys of said metals, nitrides or oxides of said metals.

9. The method of claim 1 or claim 2, wherein the catalyst surface mass is less than 100 μg/cm² of electrode.

10. The method of claim 1 or claim 2, wherein the thickness of the catalytic layer is less than 2 micrometers, preferably comprised between 10 and 100 nanometers.
